(19) United States
(12) Patent Application Publication
(10) Pub. No.: US 2006/0208143 A1
(43) Pub. Date: Sep. 21, 2006

(54) Golf bag accessory

(76) Inventor: Joseph John Romano, Plymouth Meeting, PA (US)

Correspondence Address: John Shaw Stevenson, 879 Crestline Drive, Blue Bell, PA, 19422, US

(21) Appl. No.: 11/082,996

(22) Filed: Mar. 18, 2005

(51) Int. Cl. F21V 21/00

(52) U.S. Cl. 248/222.13

(57) ABSTRACT

A unique clamping and disconnecting device for a golf club supporting apparatus is disclosed to clamp and disconnect this apparatus to a standard golf bag that is fixedly mounted on a golf cart. The clamping device has a manually operated, cam-shaped lever that can be moved into fixed engagement with the wall portion of the standard golf bag. As upward movement of the golf cart occurs due to an irregular road condition over which the cart travels, a mechanically operated unique triangular slot and pin connection prevents the golf club supporting apparatus from moving in an upward direction and out of its mounted position on the wall portion of the said golf bag.

### BACKGROUND OF THE INVENTION

1. Field of the Invention

The present invention generally relates to a clamping device for a golf club supporting apparatus to mount such apparatus on an upper wall portion of a standard golf bag that in turn is fixed to a golf cart. Golf courses require golfers to drive their carts only on specific roads which many times are a long distance from the putting green and where their balls are located on the fairway. The golfer must therefore leave his cart and the standard golf bag attached thereto on the aforementioned road and take a few clubs from his standard golf bag and carry them to the place where his ball is located on the fairway. He can then employ one or two of these clubs to drive his ball to the green and then use a putter to putt his ball into the hole on the green. Instead of manually carrying such clubs to his ball on the fairway, it is more desirable for the golfer to use a golf club supporting apparatus such as that disclosed herein to carry the clubs to where the ball is located.

2. Description of the Prior Art

Golf club supporting apparatus have employed many types of U-shaped connections to loosely fit over the open end wall of a standard golf bag and to extend downwardly along each side of this wall. With this arrangement a great deal of wear on the wall of a standard golf bag occurs because it allows such U-shaped connections to rub against this wall as the golf cart on which it is mounted experiences up and down motion from the rough surface of the road along which it is traveling. Another problem with prior art U-shaped connections is that they have a tendency to move in an upward direction and off the top of a standard golf bag during this rubbing action. To prevent such disconnection and this wear and tear, the present invention provides a unique golf club supporting apparatus that can be brought into fixed clamping engagement with the wall of this standard golf bag.

### SUMMARY OF THE INVENTION

One of the objects of the present invention is to provide a unique clamping device for a golf club supporting apparatus for clamping this apparatus to a standard golf bag that in turn is fixedly mounted on a golf cart.

Another object is to provide a device for a golf club supporting apparatus that will remain in a fixed position with the standard golf bag when the aforementioned golf cart to which the stand golf bag is attached moves in an upward or downward direction along a rough road.

It is another object of the present invention to disclose a clamping device for the aforementioned golf club supporting apparatus that employs a cam-shaped lever which can be brought into fixed relation with the wall of a standard golf bag. This apparatus also has a bar and a unique triangular slot and pin at its other end. This slot and pin connection is used to fixedly connect the golf club supporting apparatus to this clamping device for joint movement with the bag when the cart and bag are moved along a rough road. This slot and pin connection also has the ability to be disconnected when use of the golf club supporting apparatus is desired.

### BRIEF DESCRIPTION OF THE DRAWING.

The aforementioned and other objects, aspects and advantages will be better understood from the following detailed description of a preferred embodiment of the invention with reference to the drawing in which:

FIG. 1 shows a side elevation view of a clamping device that forms a part of the golf club supporting apparatus mounted on the side wall of a standard golf bag that in turn is shown retained on the rear end of a golf cart.

FIG. 2 shows a partial view of the golf club supporting apparatus and a cross sectional view of the clamping device as shown in FIG. 1.

FIG. 3. shows a view of the clamping device shown in FIG. 1 and 2 and how several golf clubs are supported in tubes forming a part of the golf club supporting apparatus.

FIG. 4 shows a unitary handle operated bar and tubes and a rod to support the tubes on the fairway of a golf course.

FIG. 4A shows a cross sectional view taken along Section 4A-$A of FIG. 4.

FIG. 5 shows a more detailed view of how the cam-shaped rod of the clamping device is assembled.

FIG. 6 shows a spring clip to retain a support rod for the golf club supporting apparatus in a fixed position on the apparatus when not in use.

### DETAILED DESCRIPTION OF A PREFERRED EMBODIMENT OF THE INVENTION

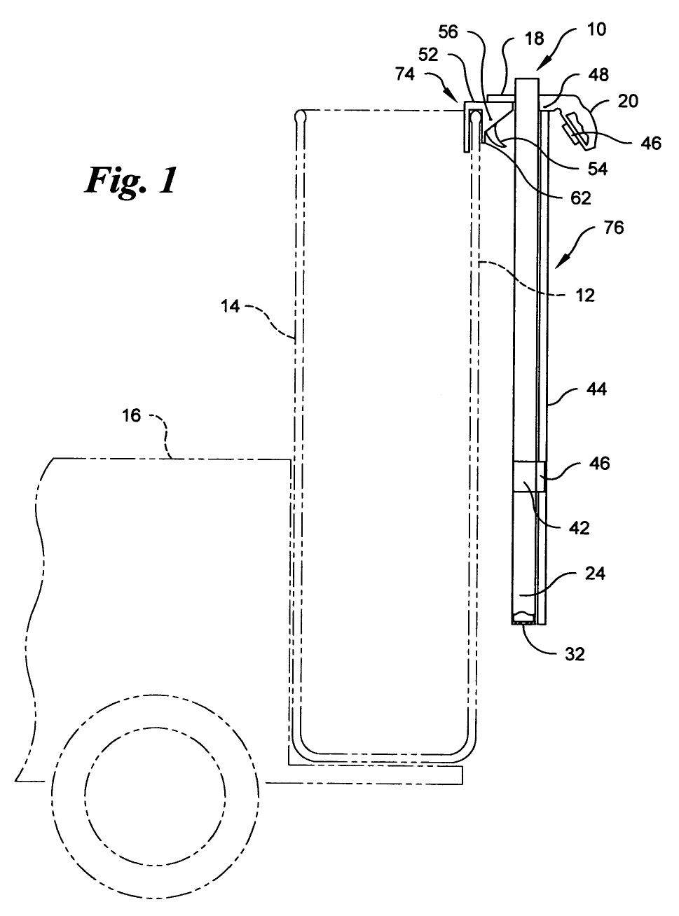

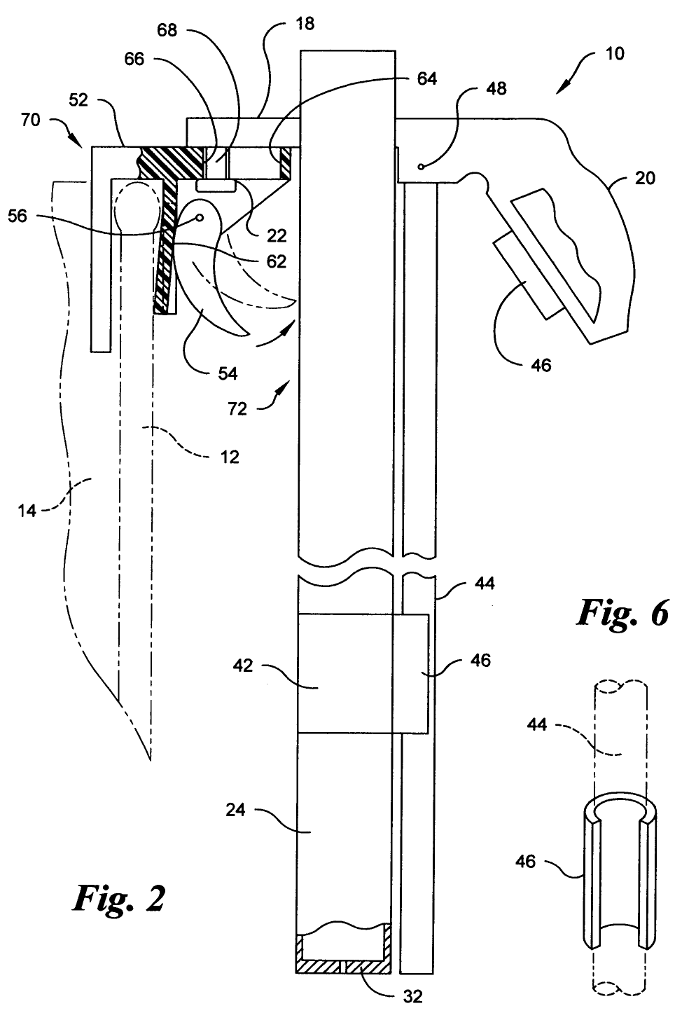

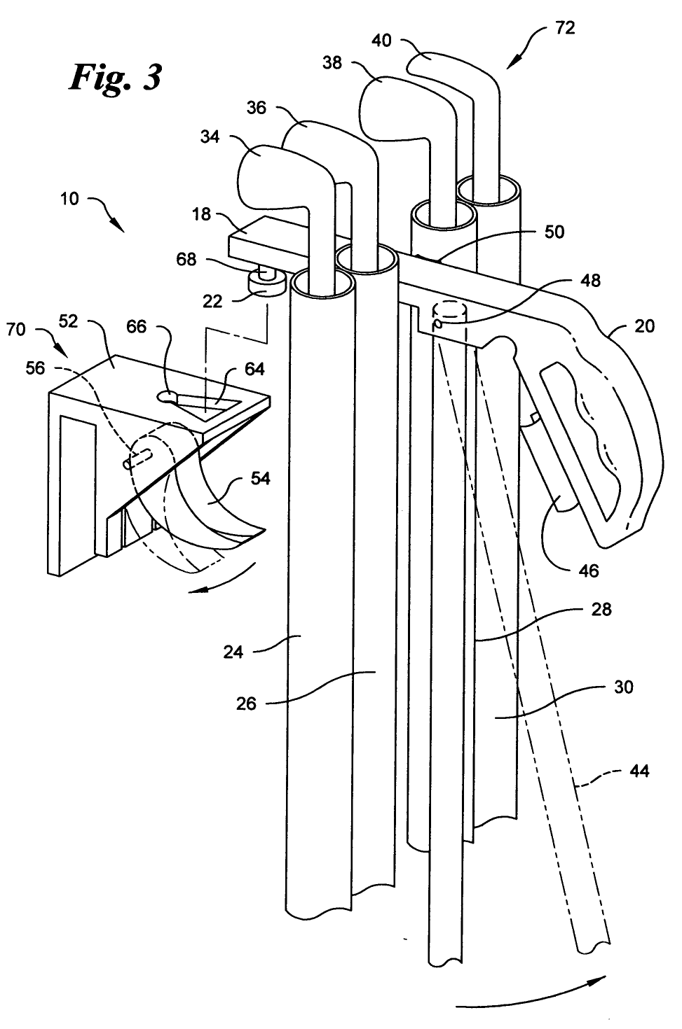

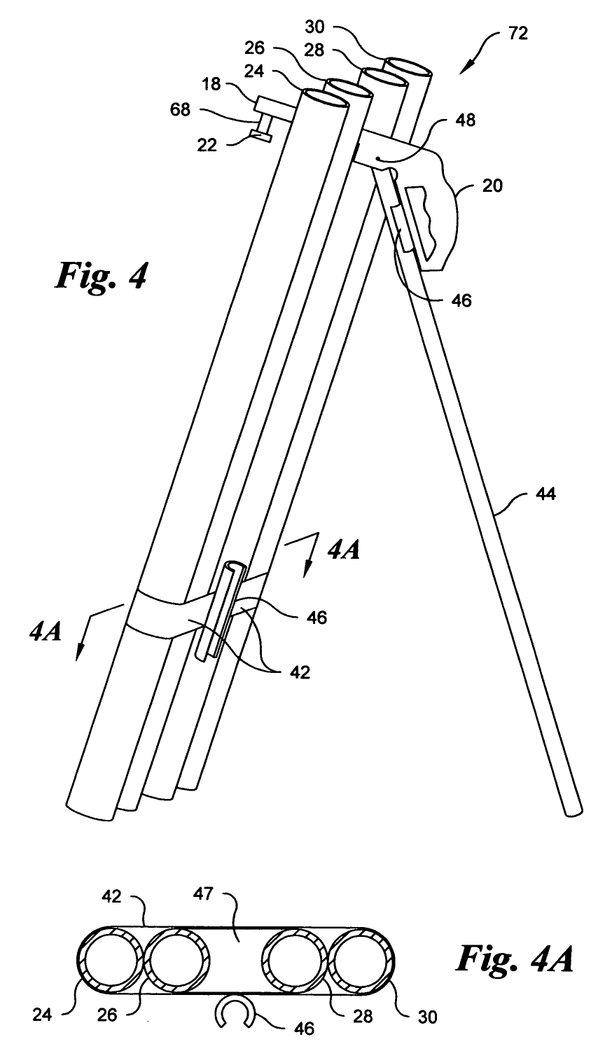

Referring more specifically to the drawings, FIG. 1 shows the golf club supporting apparatus 10 mounted on the wall 12 of a standard golf bag 14 which in turn is fixedly mounted on a golf cart 16. FIG. 2 shows a bar 18 made of a metal material having a handle 20 at one end and a circular shaped pin member 22 at its other end. FIG. 2 also shows one tube 24 of the four tubes 24, 26, 28, 30 as shown in FIGS. 3 and 4. The base of each of these four tubes 24, 26, 28, 30 as shown in FIGS. 1 and 2 are closed with a perforated plate 32 as shown, for example, in FIG. 2. This plate 32 forms a closure at the lower end of each tube 24, 26, 28, 30 to support their associated clubs 34, 36, 38, 40 thereon as best shown in FIG. 3.

FIGS. 1, 2 and 4 show by way of example how a standard strapping unit 42 is employed to fixedly connect each pair of the four tubes 24, 26, 28, 30.

FIG. 1 shows the position of a golf club supporting apparatus support rod 44 when attached to the bar 18. A spring clip 46 shown in FIG. 6 is employed to retain the rod 44 in this fixed position at its lower end to the right side of tube 26 shown in FIG. 4. As best shown in FIG. 4A the clip 46 is mounted on a plate 47 which extends between and forms an integral part of tubes 26,28. This rod 44 is pivotedly mounted on a pivot pin 48 on bar 18 at its other end.

FIGS. 1 and 2 show the bar 18 that forms a part of the golf club supporting apparatus 10 and FIG. 4 shows the position of the bar 18 when the tubes 24, 26, 28, 30 and clubs 34, 36, 38, 40 shown in FIGS. 3 and 4 have been removed for use on the fairway of a golf course. The lower closed part of the handle as shown in FIG. 4 has another one of the clips 46 that is shown in FIG. 6 mounted thereon to retain the rod 44 in an extended position.

As is best shown in FIG. 3 the bar 18 passes through the space between tubes 26 and 28 and is connected by way of example thereto by means of a plastic cement 50 or, alternatively, these parts can be made of a unitary molded construction so that the entire bar 18 and tubes 24, 26, 28, 30 supported thereby can be moved as a single unit.

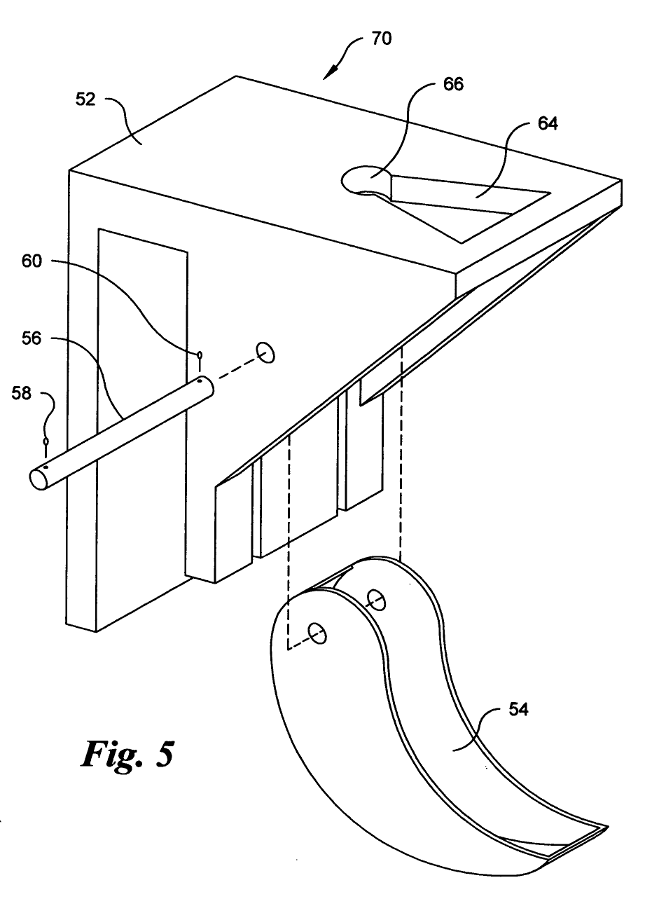

The unique clamping device for a golf club supporting apparatus as shown in FIG. 2 has a U-shaped pliable plastic member 52 for insertion over the top wall portion 12 of a standard golf bag 14. This clamping device also has a manually operable cam-shaped lever 54. FIG. 5 shows each end of the shaft 56 having two cotter pins 58, 60 to retain the cam-shaped lever 54 in the position shown. When the end of the cam-shaped lever 54 shown in FIG. 2 is pushed by an operator in a downward direction, this cam-shaped lever 54 will press the flexible right leg 62 of the U-shaped member 52 into tight engagement with the wall 12 of the standard golf bag 14. When the golf cart 16 travels over a rough road, this construction will maintain the golf cub supporting apparatus in a fixed position on the cart supported golf bag 14 and will not become disengaged by moving in an upward direction and out of engagement as heretofore been experienced with prior art devices.

As best shown in FIGS. 3 and 5 the top closed end of the U-shaped member 52 has an extendable wall portion having a triangular slot 64 therein which terminates into a substantially semicircular wall 66 of this slot. This slot 64 is big enough to allow the unitary circular-shaped pin member 22 and a smaller circular-shaped member 68 to first be moved in a downward direction through the space formed by the triangular wall forming slot 64. The member 68 can then be brought into snug engagement with slot 66 by moving it to the position as shown in FIG. 2. When this occurs, the upper surface of the pin member 22 will be in surface to surface contact with a lower surface of the extendable portion of the U-shaped member 52 as best shown in FIG. 2.

When the cam-shaped lever 54 is manually moved in clockwise direction from the position shown in FIG. 2 it will be moved into tight engagement with the wall 12 of the standard golf bag 14. Furthermore, when the circular-shaped members 22 and 68 are engaged as previously described, the entire golf club supporting apparatus 10 will be in fixed relationship to the wall 12 of the standard golf bag 14 and will then be in a position for movement as one unit with the golf bag 14. With this arrangement no irregular movement of the golf cart 16 over a rough road will be able to disengage this golf club supporting apparatus 10 from its mounting or the wall portion 12 of the standard golf bag 14. To be able to obtain a closer position on the fairway from which a golfer can drive his ball to the green and putt, it is only necessary for him to move the handlebar 20 and the circular members 22, 68 attached thereon to the right of that shown in FIG. 2 and lift it in an upward direction. This will separate the golf club supporting apparatus 10 from the standard golf bag 14 and golf cart 16 to which this bag 14 is fixedly attached. The golf club supporting apparatus 10 will then allow the golfer to readily take the apparatus 10, as best shown in FIG. 3, to the place where his ball is located. He can then place his golf club supporting apparatus 10 in the ground supporting position as shown in FIG. 4 by moving the golf bag support rod 44 to the position shown in this FIG.

Summarizing it can be seen that the golf club supporting apparatus 10 consists of two mechanisms 70 and 72. The first one of these mechanisms 70 covers a structure comprised of the U-shaped member 52 and its associated cam lever clamping means 54 for clamping leg 62 of this U-shaped member 52 to the wall 12 of a standard golf bag 14. The second one of these mechanisms 72 covers a structure comprised of the unitary four tubes 24, 26, 28, 30, bar 18 and circular shaped pin members 22, 68 for connecting and disconnecting this mechanism 72 with the first mentioned mechanism 70.

1. A golf club supporting apparatus for mounting on a wall of a standard golf bag that in turn is fixedly connected to a golf cart, said apparatus comprising a flexible U-shaped member having one of its legs extending downwardly from the top wall of said bag and along its inside wall surface and its other leg extending downwardly from the top wall of the bag along its outside surface, a cam-shaped lever mounted for rotation on a part of said apparatus, said rotatable cam-shaped lever being positioned in contact with the outside surface of said leg portion of said U-shaped member and said cam-shaped lever being manually operable to press said outside surface of said leg portion into a fixed engagement with said outside surface of the bag to thereby retain the golf club supporting apparatus in fixed relation with said standard golf bag.

2. The golf club supporting apparatus as specified in claim 1 wherein the cam-shaped lever is mounted for manual rotation on a shaft that is mounted on an extension of the closed end of said U-shaped member and wherein the manual rotation of the cam-shaped lever in a clockwise direction moves the U-shaped member into a fixed position for movement with said standard golf bag and the rotation of the cam-shaped lever in a counter-clockwise direction frees the U-shaped member from movement with said standard golf bag.

3. A golf club supporting apparatus comprising a flexible U-shaped member, said U-shaped member being positioned for engagement with the opposite sides of a wall of a standard golf bag, the base of said U-shaped member having a portion extending therefrom, a triangular shaped slot formed in said extended portion, one of the corners of said slot being of a substantially semicircular shape, a bar extending through and connected to tubes that form a portion of said supporting apparatus, said bar having a handle at the one end and a circular member protruding downwardly at its other end, said circular member being of suitable diameter for insertion in a downwardly direction through said triangular-shaped slot.

4. A golf club supporting apparatus comprising a U-shaped member, said inner wall surface of said U-shaped member being positioned for engagement with opposite sides of a wall of a standard golf bag, the base of said U-shaped member having a portion extending therefrom, a triangular shaped slot formed in said extended portion, one of the corners of said slot being of a substantially semicircular shape, a bar extending through and connected to tubes that form a portion of said supporting apparatus, said bar having a handle at the one end and a circular member protruding downwardly at its other end, said circular member being operable for movement into snug locking engagement with the semicircular portion of said slot, said handlebar and its associated cylindrical member being operable for moving away from this semicircular portion in the slot and thence in an upward direction to free said golf club supporting apparatus from said extendable portion of said U-shaped member and said standard golf bag.

5. A device for connecting and disconnecting a golf club supporting apparatus with a standard golf bag comprising a rotatable cam-shaped lever mounted for rotation on a flexible mechanical structure for engaging the wall of a standard golf bag, a handlebar, a plurality of tubes supported for movement on said bar, a pin and slot connection between said bar and said mechanical structure and wherein movement of said handlebar is operable to connect and disconnect said tubes from said flexible mechanical structure.

6. A golf club supporting apparatus comprising a first structure having a first means for connecting said apparatus to and disconnecting said apparatus from the wall of a standard golf bag, and having a second structure that has a second means to connect and disconnect a remaining portion of said club supporting apparatus from said first structure.

7. A golf club supporting apparatus comprising a first structure having a first means for connecting said apparatus to and disconnecting it from a standard golf bag and having a second structure that has a second means to connect and disconnect a remaining portion of said club supporting apparatus from said first structure, said second structure being provided with a handle and connecting device attached thereto to enable said second structure to be manually moved between said connected and disconnected positions with the said first structure.

8. A device to connect and disconnect a golf club supporting apparatus with a standard golf bag comprising a bar having a handle at one end and a means to connect and disconnect it to said standard golf bag at its other end, tubes fixedly positioned on either side of the central portion of said bar and wherein said bar and it associated means being operable when moved in one direction to disconnect said golf club supporting apparatus from said standard golf bag and when moved in an opposite direction being operable to connect said supporting apparatus with said standard golf bag.

9. A golf club supporting apparatus comprising a first structure having a first means for connecting said apparatus to and disconnecting said apparatus from the wall of a standard golf bag, and having a second structure that has a second means to connect and disconnect a remaining portion of said club supporting apparatus from said first structure, a cam lever mounted on said first structure for rotation in one direction to fixedly connect said first structure with said wall of said standard golf bag and wherein rotation of the cam lever in the opposite direction is employed to release said first structure from said wall of said golf bag.

10. A golf club supporting apparatus comprising a first structure having a first means for connecting and disconnecting said club supporting apparatus with a standard golf bag, a second structure having a means to connect it to and disconnect it from said first structure, said second structure being provided with a series of tubes supported on a handlebar and wherein said handlebar is provided with a device to enable said second structure to be connected and disconnected from said first structure.
